(19) United States
(12) Patent Application Publication
(10) Pub. No.: US 2026/0180777 A1
(43) Pub. Date: Jun. 25, 2026

(54) DYNAMIC TIME-DIVISION DUPLEXING CONTROL METHOD AND SYSTEM FOR UAV-ASSISTED 6G HOTSPOT NETWORK

(71) Applicant: CHUNG ANG UNIVERSITY INDUSTRY ACADEMIC COOPERATION FOUNDATION, Seoul (KR)

(72) Inventors: Sungrae CHO, Seongnam-si (KR); Dong Hyun LEE, Seoul (KR); Chi Hyun SONG, Seoul (KR); Van Dat Tuong, Seoul (KR)

(21) Appl. No.: 19/355,624

(22) Filed: Oct. 10, 2025

(30) Foreign Application Priority Data
Dec. 20, 2024 (KR) 10-2024-0192431

(51) Int. Cl. H04L 5/14; H04B 7/185; H04W 64/00

(52) U.S. Cl. CPC H04L 5/14; H04B 7/18504; H04W 64/00

(57) ABSTRACT

A dynamic time-division duplexing (D-TDD) control method and system for a UAV-assisted 6G small-cell network includes: collecting geographic information and channel states for base stations (BSs) and user equipment (UEs) within a network coverage area and converting the collected data into a traffic demand density matrix; applying the traffic demand density matrix to a sparse convolutional neural network (CNN) model to extract a feature vector; defining the extracted feature vector as a current state, inputting the current state into a reinforcement learning (RL) model, and determining, by the RL model based on the current state, an action for reconfiguring a slot configuration of a BS; and, in response to the determined action, reconfiguring the slot configuration of the BS and computing a state transition and a reward value.

### CROSS-REFERENCE TO RELATED APPLICATION

This application claims the benefit of priority under 35 U.S.C. § 119 (a) to Korean Patent Application No. 10-2024-0192431, filed on Dec. 20, 2024, the entire contents of which is incorporated herein by reference.

### BACKGROUND

### (a) Technical Field

The present disclosure relates to a dynamic time division duplexing (D-TDD) control method and system for UAV-assisted 6G small-cell networks.

### (b) Background Art

Conventional time-division duplexing (TDD) techniques are classified into static and dynamic time-resource partitioning. In the static scheme, a base station's time-resource partition is predetermined, and different time resources are allocated to the uplink and the downlink so that the two directions are separated in transmission time. Such static TDD, however, fails to cope with interference arising from multi-user communication demands and with variations in dynamic traffic demand, resulting in inefficient allocation of radio resources.

To overcome these limitations, dynamic time-division duplexing (D-TDD) has been developed, which dynamically allocates the slot configuration between uplink and downlink transmissions and adaptively reconfigures each heterogeneous network in response to changes in traffic demand. This enables low latency and high throughput while improving the quality of service (QoS) for all users.

Unmanned aerial vehicle (UAV) communication technology, which employs UAVs equipped with wireless communication transceivers to provide a reliable communications environment, is a key enabling technology for 6G. In particular, dynamic time-division duplexing in UAV-assisted small-cell systems has gained prominence as a new system-control approach in 6G networks, driven by the rapid proliferation of Internet-of-Things (IoT) devices.

However, conventional techniques adopt centralized or distributed control for time-division slot configuration, which requires accurate exchange of channel state information (CSI) among base stations. The CSI exchange and state estimation incur excessive computational latency and communication overhead, and inaccuracies therein degrade the performance of the slot-configuration control. In addition, although approaches such as machine learning, game theory, and reinforcement learning have been proposed to reduce communication cost, they do not eliminate it and typically require long training times.

### SUMMARY OF THE DISCLOSURE

The present disclosure is directed to a method and system for dynamic time-division duplexing (D-TDD) control in a UAV-assisted 6G small-cell network.

In one aspect, a UAV collects geographic information and channel states within the network coverage, converts the collected data into features using a sparse convolutional filter, defines the extracted features as a state, inputs the state into a reinforcement learning model, and determines an optimal slot configuration.

According to one aspect of the present disclosure, a dynamic time-division duplexing (D-TDD) control method for a UAV-assisted 6G small-cell network is provided.

According to one embodiment, the method comprises: collecting geographic information and channel states for base stations (BSs) and user equipment (UEs) within a network coverage area and converting the same into a traffic demand density matrix; applying the traffic demand density matrix to a sparse convolutional neural network (CNN) model to extract a feature vector; defining the extracted feature vector as a current state, inputting the current state into a reinforcement learning (RL) model, and determining, by the RL model based on the current state, an action for reconfiguring a slot configuration of a BS; and, in response to the determined action, reconfiguring the slot configuration of the BS and computing a state transition and a reward value.

The slot configuration comprises an uplink (UL) state, a downlink (DL) state, and a flexible (F) state, the flexible state assigning no specific transmission direction and being a state in which neither throughput nor interference occurs.

The converting into the traffic demand density matrix comprises: partitioning the network coverage into grids or cells of a predetermined size; for each grid or cell, calculating a traffic density value by summing a number of user equipment (UEs) within the grid or cell and an amount of traffic requested by the UEs within the grid or cell; and generating, based on the respective traffic density values, a traffic demand density matrix for the entire network coverage.

To construct the traffic demand density matrix, each base station is positioned at the origin of a local coordinate system, and the location information of user equipment (UEs) connected to the base station and unconnected UEs is stored in tuple form.

The traffic demand density matrix may include a first density matrix for the downlink traffic density of served (connected) UEs, a second density matrix for the uplink traffic density of served (connected) UEs, a third density matrix for the downlink traffic density of unconnected UEs, and a fourth density matrix for the uplink traffic density of unconnected UEs.

The reward value is calculated using the following mathematical expression.

$$U ( t ) = {\sum }_{u = 1}^{U} {\sum }_{k = 0}^{K} {( {R}_{u , k , n}^{UL} ( t ) + {R}_{u , k , n}^{DL} ( t ) )}_{n = t \% N}$$

wherein, u denotes an index of a user equipment (UE), k denotes an index of a base station (BS), n denotes a time index,

$${R}_{u , k , n}^{UL} ( t )$$

denotes the uplink transmission rate between UE u and BS k at time n, and

$${R}_{u , k , n}^{DL} ( t )$$

denotes the downlink transmission rate between UE u and BS k at time n.

The method may further include storing, in a replay buffer, a tuple comprising the current state, the selected action, the reward value, and a next state, and training the reinforcement learning model by randomly sampling tuples from the replay buffer.

According to another aspect of the present disclosure, an apparatus for performing the dynamic time-division duplexing (D-TDD) control method in a UAV-assisted 6G small-cell network is provided.

In one embodiment, an unmanned aerial vehicle (UAV) equipped with a camera and a LiDAR comprises: a communication unit; a memory storing one or more instructions; and a processor configured to execute the instructions to: collect geographic information and channel states for base stations (BSs) and user equipment (UEs) within a network coverage area and convert the same into a traffic demand density matrix; apply the traffic demand density matrix to a sparse convolutional neural network (CNN) model to extract a feature vector; define the extracted feature vector as a current state, input the current state into a reinforcement learning (RL) model, and determine, based on the current state, an action for reconfiguring a slot configuration of a BS; and, in response to the determined action, reconfigure the slot configuration of the BS and compute a state transition and a reward value.

By providing the dynamic time-division duplexing (D-TDD) control method and system for a UAV-assisted 6G small-cell network according to an embodiment of the present disclosure, optimal D-TDD control can be achieved by collecting geographic information and channel states via a UAV, applying a sparse convolution filter to extract features, defining the extracted features as a state, inputting the state into a reinforcement learning model, and determining an optimal slot configuration.

In addition, the invention provides superior average per-UE throughput with low complexity and near-optimal performance, thereby enabling efficient deployment in 6G small-cell network environments.

### BRIEF DESCRIPTION OF DRAWINGS

FIG. 1 is a schematic diagram illustrating a network system configuration according to an embodiment.

FIG. 2 is a diagram illustrating a radio frame structure.

FIG. 3 is a flowchart illustrating a dynamic time-division duplexing (D-TDD) control method for a UAV-assisted 6G small-cell network according to an embodiment.

FIG. 4 is a diagram illustrating a traffic demand state according to an embodiment.

FIG. 5 is a diagram provided to explain a traffic demand density matrix according to an embodiment.

FIG. 6 is a diagram illustrating an overall framework according to an embodiment.

FIG. 7 is a diagram illustrating system-level simulation parameters according to an embodiment.

FIG. 8 is a diagram illustrating convergence of an algorithm according to an embodiment.

FIG. 9 is a diagram comparing cumulative distribution functions (CDFs) of throughput between conventional techniques and an embodiment of a UAV-assisted 6G small-cell D-TDD control method.

FIG. 10 is a diagram comparing performance versus the number of user equipment (UEs) between conventional techniques and an embodiment of a UAV-assisted 6G small-cell D-TDD control method.

FIG. 11 is a diagram comparing performance versus the number of small-cell base stations (BSs) between conventional techniques and an embodiment of a UAV-assisted 6G small-cell D-TDD control method.

FIG. 12 is a diagram comparing uplink and downlink throughputs of macro-cell users and small-cell users between conventional techniques and an embodiment of a UAV-assisted 6G small-cell D-TDD control method.

FIG. 13 is a block diagram schematically illustrating an internal configuration of an unmanned aerial vehicle (UAV) according to an embodiment.

### DETAILED DESCRIPTION

Singular forms used in this specification include plural forms unless the context clearly indicates otherwise. In the specification, the term “configured”, “include”, or the like should not be construed as necessarily including several components or several steps described herein, in which some of the components or steps may not be included or additional components or steps may be further included. Further, the terms “˜ unit”, “module”, and the like mean a unit for processing at least one function or operation and may be implemented by hardware or software or by a combination of hardware and software.

Hereinafter, the embodiments of the present disclosure will be described in detail with reference to the accompanying drawings.

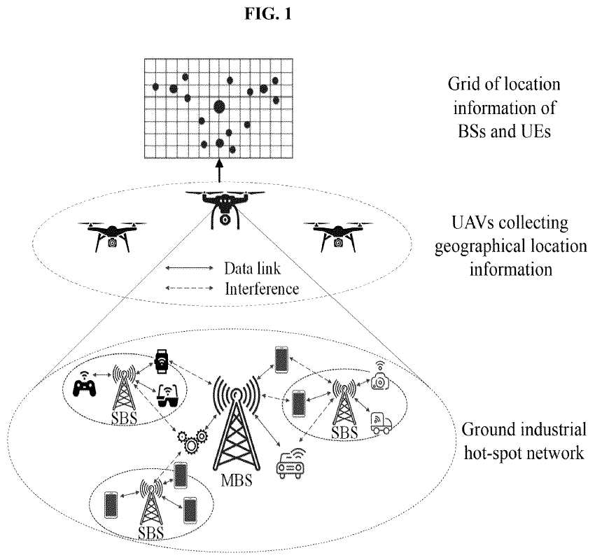

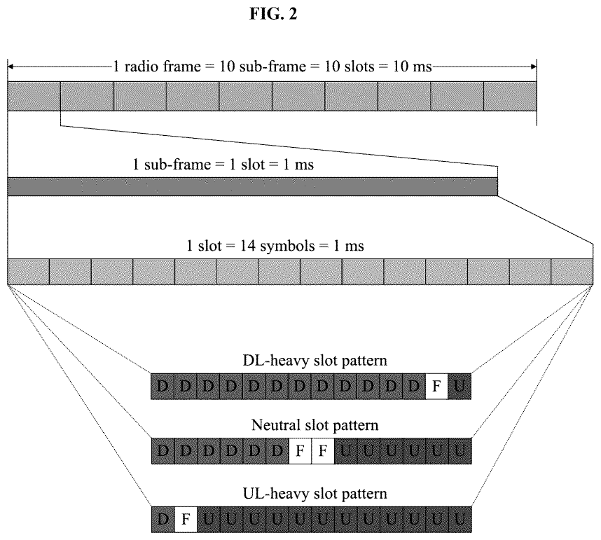

FIG. 1 is a schematic diagram illustrating a network system configuration according to an embodiment, and FIG. 2 is a diagram illustrating a radio frame structure.

As shown in FIG. 1, the UAV-assisted network is a cellular network system in which multiple heterogeneous are distributed within a macro-cell coverage. In a network system according to an embodiment, an unmanned aerial vehicle (UAV) is deployed and, via the UAV, geographic information within the network coverage is collected and channel states are measured concurrently. Hereinafter, each base station (BS) is denoted by k∈{0,1, . . . K}.

The macro-cell base station (MBS) is assumed to employ a three-dimensional (3D) antenna array, and each small-cell base station (SBS) is assumed to be equipped with a single antenna, the MBS and the SBSs may provide service to user equipment (UEs). The UEs are assumed to be uniformly distributed within the coverage of each cell and are denoted by u∈{1, . . . , U}.

Each user equipment (UE) measures a reference signal received power (RSRP) for channel estimation and is served by the base station (BS) that provides the maximum received power, the association is denoted by an indicator k_{u,k}=1.

All base stations use the same frequency band; however, within each cell, the UEs share the frequency resources via orthogonal frequency-division multiple access (OFDMA). The orthogonal subchannels of each base station are denoted by s∈S={1, . . . , s}.

It is assumed that no intra-cell interference exists and only inter-cell interference is present.

It is assumed that, by employing multiple UAVs, the entire network coverage is observable; that is, multiple UAVs are deployed so that the whole coverage area can be monitored, and, via the UAVs, location information of all base stations and devices (UEs) within the coverage can be collected. Each cell distinguishes uplink and downlink by dynamic time-division duplexing (D-TDD), and the frame configuration is assumed to be dynamically reconfigurable. Accordingly, all network cells can independently and dynamically change their uplink/downlink time-slot configuration.

In accordance with 3GPP TS 38.211, the subcarrier spacing and the corresponding slot duration are classified into five numerologies, denoted by μ∈(0, . . . , 4).Consistent with the 5G NR standard, symbol-level configuration is supported, therefore, each cell may change its slot pattern according to traffic demand.

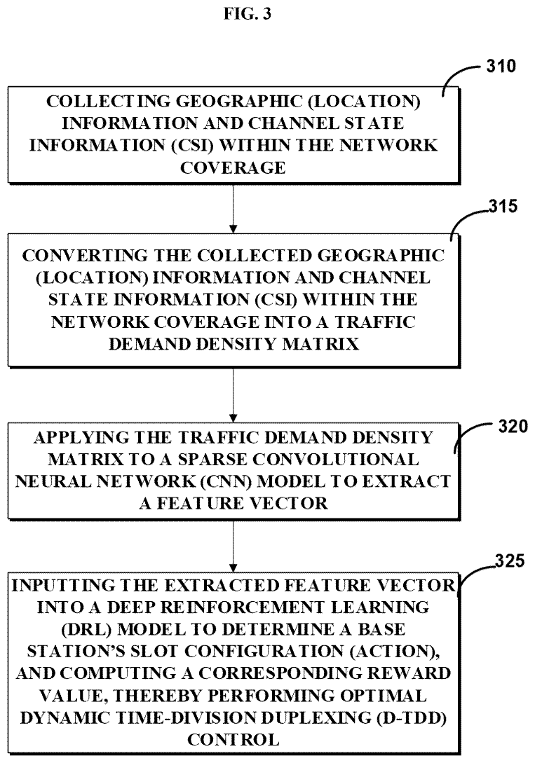

Hereinafter, with reference to FIG. 3, a dynamic time-division duplexing (D-TDD) control method for a UAV-assisted 6G small-cell network will be described.

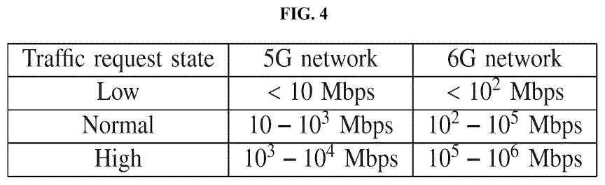

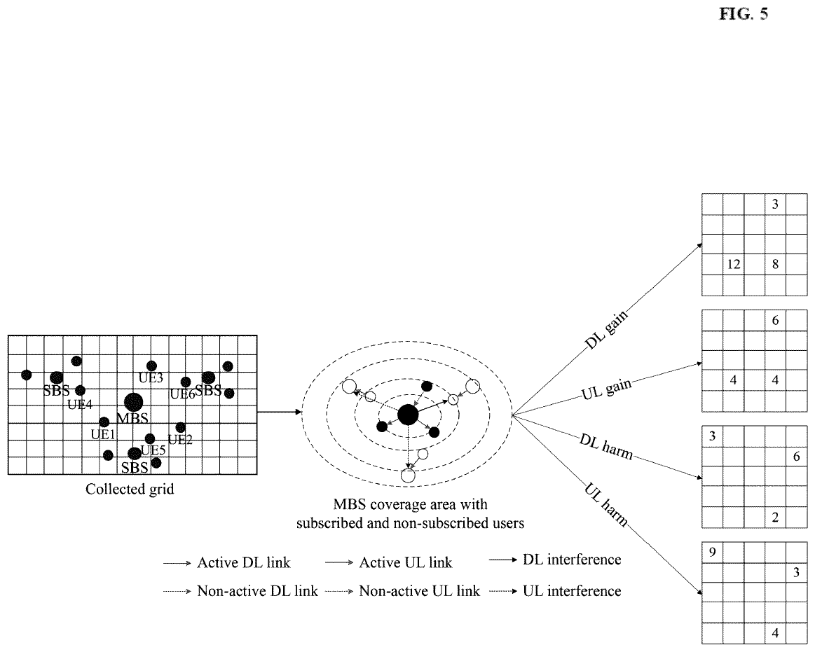

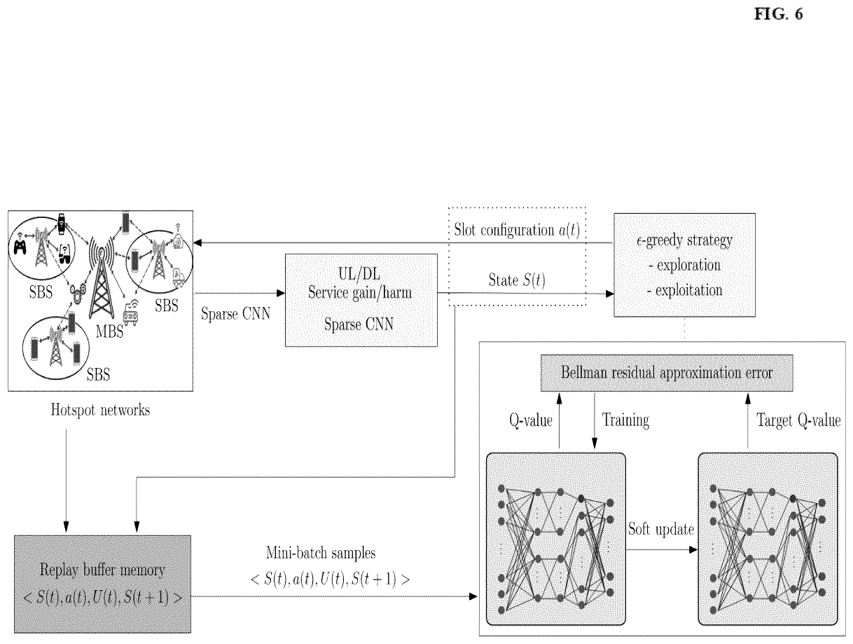

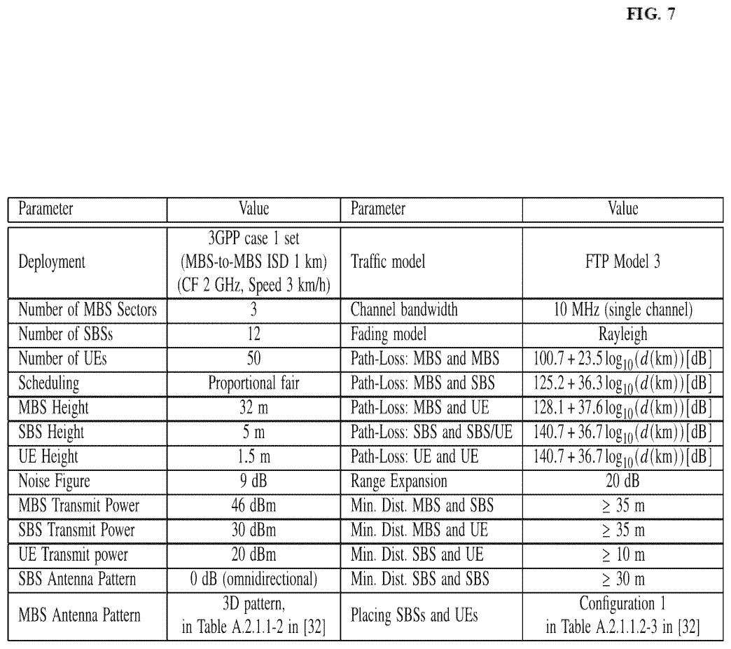

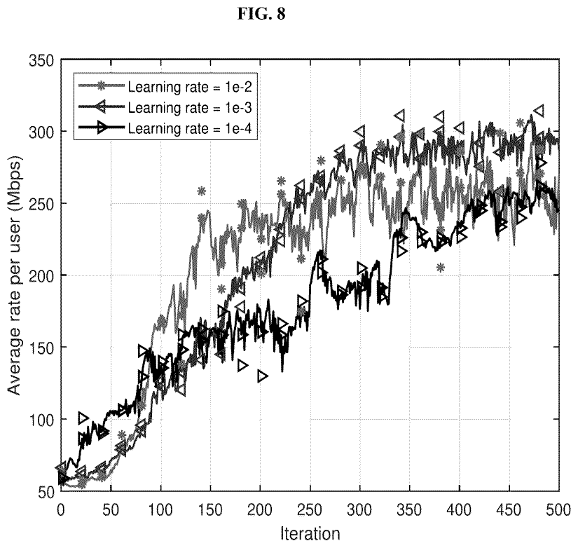

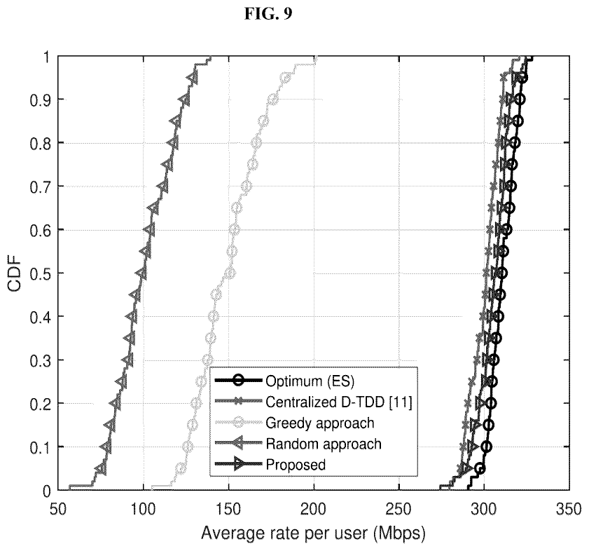

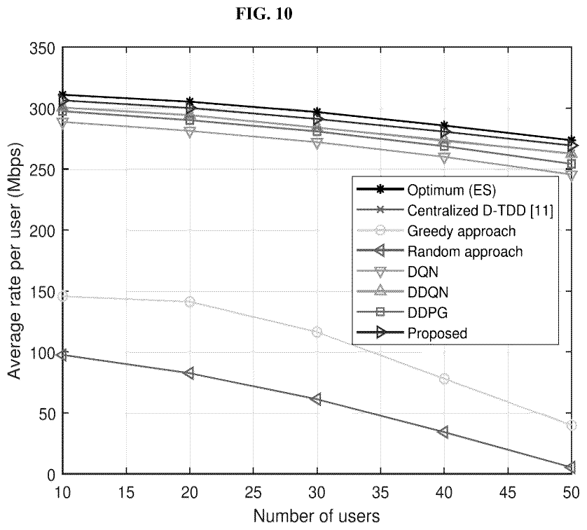

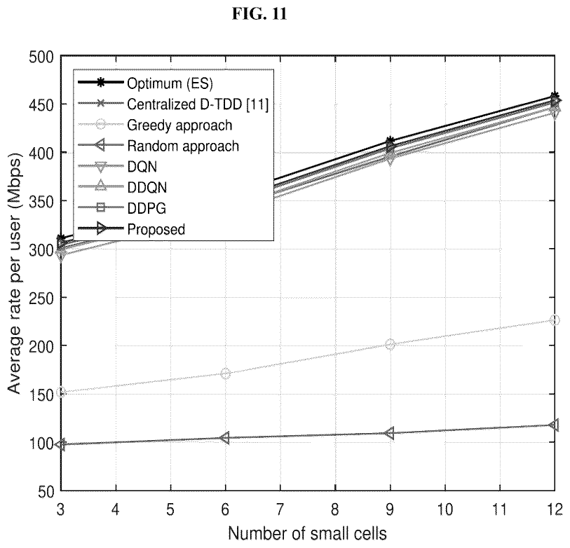

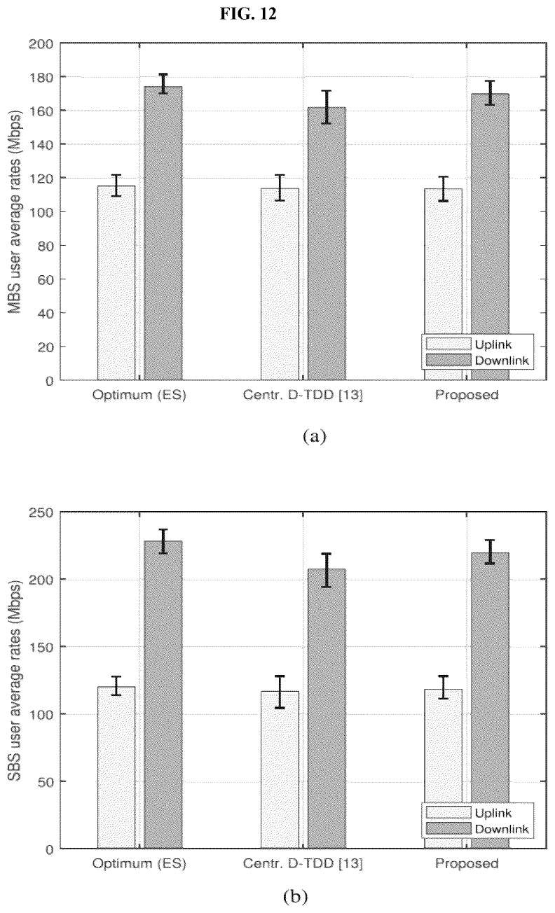

FIG. 3 is a flowchart illustrating a dynamic time-division duplexing (D-TDD) control method for a UAV-assisted 6G small-cell network according to an embodiment, FIG. 4 is a diagram illustrating a traffic demand state according to an embodiment, FIG. 5 is a diagram provided to explain a traffic demand density matrix according to an embodiment, FIG. 6 is a diagram illustrating an overall framework according to an embodiment, FIG. 7 is a diagram illustrating system-level simulation parameters according to an embodiment, FIG. 8 is a diagram illustrating convergence of an algorithm according to an embodiment, FIG. 9 is a diagram comparing cumulative distribution functions (CDFs) of throughput between conventional techniques and an embodiment of a UAV-assisted 6G small-cell D-TDD control method, FIG. 10 is a diagram comparing performance versus the number of user equipment (UEs) between conventional techniques and an embodiment of a UAV-assisted 6G small-cell D-TDD control method, FIG. 11 is a diagram comparing performance versus the number of small-cell base stations (BSs) between conventional techniques and an embodiment of a UAV-assisted 6G small-cell D-TDD control method, FIG. 12 is a diagram comparing uplink and downlink throughputs of macro-cell users and small-cell users between conventional techniques and an embodiment of a UAV-assisted 6G small-cell D-TDD control method.

In step 310, the UAV collects geographic (location) information and channel state information (CSI) within the network coverage.

As shown in FIG. 1, multiple UAVs are deployed to sufficiently observe the entire network coverage, whereby geographic (location) information of all base stations (BSs) and user equipment (UEs) can be collected. Each cell is separated into uplink and downlink by dynamic time-division duplexing (D-TDD), and the frame configuration can be dynamically reconfigured.

The transmit power allocated to a signal is assumed to be constant, the uplink transmit power is denoted by

$${p}_{u , k , s}^{UL} ,$$

and the downlink transmit power is denoted by

$${p}_{u , k , s}^{DL} .$$

If a subchannel s is allocated to UE u, an allocation indicator η_{u,k,s} is set to 1, otherwise, it is set to 0.

The channel power gain may be expressed as Equation 1.

$${g}_{u , k}^{s} = {\vert {h}_{u , k}^{s} \vert}^{2} {α}_{u , k} \qquad [ Equation 1 ]$$

### Herein,

$${h}_{u , k}^{s}$$

denotes the small-scale fading component, and α_{u,k} denotes the large-scale path-loss component.

Under the 5G NR configuration, each slot format is within a number of consecutive time slots denoted by N which corresponds to a transmission time interval. Let x_{k,n}|N∈ [symbol] ={1, . . . , N} denote the slot configuration at time n of BS k. x_{k,n} takes one of three values in {−1, 0, 1}, which denote an uplink (UL) configuration, a flexible (F) state, and a downlink (DL) configuration, respectively.

At time n, for user equipment u and base station k, the signal-to-interference-plus-noise ratio (SINR) for uplink (UL) and downlink (DL) transmissions can be expressed by Equations 2 and 3, respectively.

$${Υ}_{u , k , n}^{UL} = \frac{{1}_{( {x}_{k , n} = - 1 )} {κ}_{u , k} {η}_{u , k , s} {g}_{u , k}^{s} {p}_{u , k , s}^{UL}}{{\sum }_{v ∈ 𝒰 \backslash \{ u \}} [ ( {1}_{( {x}_{{l}_{v} , n} = - 1 )} {I}_{v , k , s} + {1}_{( {x}_{{l}_{v} , n} = 1 )} {I}_{{l}_{v} , k , s} ] + {σ}^{2}} \qquad [ Equation 2 ]$$

$${Υ}_{u , k , n}^{DL} = \frac{{1}_{( {x}_{k , n} = 1 )} {κ}_{u , k} {η}_{u , k , s} {g}_{u , k}^{s} {p}_{u , k , s}^{DL}}{{\sum }_{v ∈ 𝒰 \backslash \{ u \}} [ {1}_{( {x}_{{l}_{v} , n} = - 1 )} {I}_{v , u , s} + {1}_{( {x}_{{l}_{v} , n} = 1 )} {I}_{{l}_{v} , u , s} ] + {σ}^{2}} \qquad [ Equation 3 ]$$

Where 1(*) denotes a binary function such that 1(x)=1 if * is true, otherwise 1(*)=0. If lᵥ

I_{v,k,s} and I_{v,u,s} respectively denote the interferences from UE v to BS k and UE u, respectively. Additionally, Iₗ_{ᵥ}_{,k,s} and Iₗ_{ᵥ}_{,u,s} denote the interferences from BS lᵥ to BS k and UE u, respectively, and σ² denotes the additive white Gaussian noise power spectral density. Each interference term may be computed using Equation 4 through Equation 7.

$${I}_{v , k , s} = {κ}_{v , {l}_{v}} {η}_{v , {l}_{v} , s} {p}_{v , {l}_{v} , s}^{UL} {g}_{v , k}^{s} \qquad [ Equation 4 ]$$

$${I}_{{l}_{v} , k , s} = {κ}_{v , {l}_{v}} {η}_{v , {l}_{v} , s} {p}_{v , {l}_{v} , s}^{DL} {g}_{k , {l}_{v}}^{s} \qquad [ Equation 5 ]$$

$${I}_{v , u , s} = {κ}_{v , {l}_{v}} {η}_{v , {l}_{v} , s} {p}_{v , {l}_{v} , s}^{UL} {g}_{u , v}^{s} \qquad [ Equation 6 ]$$

$${I}_{{l}_{v} , u , s} = {κ}_{v , {l}_{v}} {η}_{v , {l}_{v} , s} {p}_{v , {l}_{v} , s}^{DL} {g}_{u , {l}_{v}}^{s} \qquad [ Equation 7 ]$$

$${g}_{k , {l}_{v}}^{s} and {g}_{u , v}^{s}$$

respectively denote the channel power gains, on subchannel s, from base station lᵥ to base station k and from user equipment v to user equipment u. At time n, the uplink (UL) and downlink (DL) transmission rates between user equipment (UE) u and base station (BS) k are defined by Equations 8 and 9, respectively, where W denotes the subchannel bandwidth.

$${R}_{u , k , n}^{UL} = W \times {log}_{2} ( 1 + {Υ}_{u , k , n}^{UL} ) \qquad [ Equation 8 ]$$

$${R}_{u , k , n}^{DL} = W \times {log}_{2} ( 1 + {Υ}_{u , k , n}^{DL} ) \qquad [ Equation 9 ]$$

The optimal control scheme for maximizing the network-wide sum rate is formulated as the optimization problem of Equation 10, subject to the constraints in Equation 10a.

$$\begin{matrix}[ Equation 10 ] & \\ {max}_{x} {\sum }_{u = 1}^{U} {\sum }_{k = 0}^{K} {\sum }_{n = 1}^{N} ( {R}_{u , k , n}^{UL} + {R}_{u , k , n}^{DL} ) & ( 10 a )\end{matrix}$$

$$s . t . {x}_{k , n} ∈ \{ - 1 , 0 , 1 \} , ∀ k ∈ 𝒦 ; ∀ n ∈ 𝒩$$

Where, the variable X=(z_{k,u}|k∈K,n∈N) denotes the slot configuration of all base station.

To address this in a cost-efficient manner, instead of employing a channel-information-based algorithm, a geographic-information-based traffic-demand density may be obtained via a spatial convolution filter.

Assuming that user locations remain unchanged during a data transmission period T, the association between each user equipment (UE) and base station (BS) is maintained throughout the period and no inter-BS handover occurs. In addition, BS coverage areas may overlap, and an overlap region may include both UEs associated with the BS and UEs associated with other BSs. Accordingly, the slot configuration determined at each BS, and the scheduling decisions based thereon, shall take into account both inter-cell interference and achievable service throughput.

In step 315, the UAV converts the collected geographic (location) information and channel state information (CSI) within the network coverage into a traffic demand density matrix.

In an embodiment of the present disclosure, to evaluate and learn the effects of such interference, geographic information and channel states are collected via the UAV, converted into a traffic demand density matrix, and used to train a convolutional neural network (CNN), whereby uplink and downlink throughput and interference can be measured.

The geographic information obtained by the UAV (i.e., base-station locations and UE locations) may be represented in matrix form as {{lₖ|k=0, . . . , K), (lᵤ|u=0, . . . , U}}. Assuming that the coverage area of an arbitrary base station BSₖ is a circle of radius rₖ, this circle may be divided into multiple Z smaller circles indexed as 1, . . . , Z in increasing order, i.e., a smaller circle is assigned a larger index. User equipment located in smaller circles experience higher received power than those located in larger circles. The relative signal strength of the users located in each circle z∈{1, . . . , Z} may be quantized by its index z.

To construct, for each network cell, a grid matrix of traffic-demand density, each base station is set as the origin of a local coordinate system, and the position information of connected and unconnected user equipment (UEs) is stored in tuple form.

The geographical location information of each network cell is represented using the tuple

$$〈 ( {l}_{1}^{U} , … , {l}_{{Ω}_{k}}^{U} ) , ( {l}_{1}^{K} , … , {l}_{{Ξ}_{k}}^{K} ) , {( {l}_{1}^{NU} , … , {l}_{{Φ}_{k}} )}^{NU} 〉 ,$$

where Ωₖ denotes the number of subscribed users of BS k, Ξₖ denotes the number of adjacent BSs of BS k, Φₖ denotes the number of non-subscribed users of BS k that are located in the coverage area of BS k.

Additionally, the traffic-demand state of UEs within the coverage area may be quantized and, to ensure fair quality of service (QoS), may be divided—depending on the network standard—into three intervals, as illustrated in FIG. 4.

Based on the geographic-information tuples and the traffic-demand state, four grid matrices can be constructed as illustrated in FIG. 5, which partition—into four categories—the effects of uplink throughput, downlink throughput, and inter-cell interference.

The first density matrix represents the downlink traffic density of served (connected) user equipment (UEs); the second density matrix represents the uplink traffic density of served (connected) UEs; the third density matrix represents the downlink traffic density of unconnected UEs; and the fourth density matrix represents the uplink traffic density of unconnected UEs.

The value of each density-matrix cell may be computed as the sum, over all UEs within the grid, of the products of each UE's quantized traffic-demand state and the index [symbol] of the largest concentric circle to which the UE belongs.

In step 320, the UAV applies the traffic demand density matrix to a sparse convolutional neural network (CNN) model to extract a feature vector.

In one embodiment, with the traffic demand density matrix as input, the effects on achievable throughput and interference are computed using a spatial convolution filter. The weights of the spatial convolution filter are optimized through convolutional neural network (CNN) training, and their values may be determined based on the receive-side channel gains at the base stations.

Given that the traffic demand density matrix is very high-dimensional and exhibits high randomness depending on the environment, the computational cost is substantial. Accordingly, in an embodiment, a sparse convolution block employing speed-accuracy balancing (SAB) and deep feature processing (DFP) may be used.

In one embodiment, the sparse convolutional neural network includes one or more sparse convolution blocks, to prevent loss of inter-block feature vectors caused by sparsification, skip connections are added so as to enable feature sharing among the sub-blocks.

In step 325, the UAV inputs the extracted feature vector into a deep reinforcement learning (DRL) model to determine the base station's slot configuration (action) and computes a corresponding reward value, thereby performing optimal dynamic time-division duplexing (D-TDD) control.

This will be described in more detail below.

The deep reinforcement learning model according to an embodiment of the present disclosure may be based on a deep dueling Deep Q-learning architecture.

The deep reinforcement learning model separates the valuation of the current state from the valuation of each action. In particular, as an algorithm suitable for high-dimensional decision making, the neural network is partitioned into two layers—a state-value layer and an action (advantage) layer—which are combined at the final output, thereby avoiding unnecessary estimation and improving convergence and stability.

For training, the TDD slot-configuration control optimization problem defined in Equation (10) may first be transformed into the long-term, time-evolving decision problem of Equation (11).

$$\begin{matrix}[ Equation 11 ] & \\ {max}_{x} 𝔼 [ {\sum }_{t = 1}^{T} {γ}^{t - 1} {\sum }_{u = 1}^{U} {\sum }_{k = 0}^{K} {( {R}_{u , k , n}^{UL} + {R}_{u , k , n}^{DL} )}_{n = t \% N} ] & ( 11 a )\end{matrix}$$

$$s . t . {x}_{k , n} ∈ \{ - 1 , 0 , 1 \} , ∀ k ∈ 𝒦 ; ∀ n ∈ 𝒩$$

Here, 7 denotes a time-dependent discount factor with a value between 0 and 1.

In an embodiment, the reinforcement learning (RL) model is deployed on the UAV to control the slot-configuration vector x of all base stations, with the objective of maximizing long-term aggregate throughput. To learn a policy that approaches the optimum, the RL agent periodically interacts with the network environment: at time t, it observes a state S(t) selects an action a(t) (i.e., a slot configuration), observes the resulting state transition S(t+1), and computes a corresponding reward U(t).

The state S(t) defined as in Equation (12), where χₖ(φ_{DL}φ_{UL}ψ_{DL}ψ_{DL}) denotes the feature vector extracted from the traffic-demand density matrix corresponding to network cell k.

$$S ( t ) ← [ \{ {χ}_{k} ( {φ}_{DL} , {φ}_{UL} , {ψ}_{DL} , {ψ}_{UL} ) \vert ∀ k ∈ 𝒦 \} , a ( t - 1 ) ] \qquad [ Equation 12 ]$$

The action a(t) corresponds to the slot configuration of each base station and takes one of three values in xₖ(t)∈{−1.0.1}, which respectively denote an uplink (UL) state, a flexible (F) state, and a downlink (DL) state.

The flexible state represents a condition in which neither uplink nor downlink transmission is scheduled and, accordingly, neither throughput nor interference occurs.

The reward function U(t) is the aggregate throughput of all user equipment (UEs) and can be expressed as Equation (13).

$$U ( t ) = {\sum }_{u = 1}^{U} {\sum }_{k = 0}^{K} {( {R}_{u , k , n}^{UL} ( t ) + {R}_{u , k , n}^{DL} ( t ) )}_{n = t \% N} \qquad [ Equation 13 ]$$

The value functions for the state-action pair (S,a) and for the current state S may be expressed as Equations 14 and 15, respectively.

$${Q}_{π} ( S , a ) = 𝔼 [ U ( t ) \vert S ( t ) = S , a ( t ) = a , π ] \qquad [ Equation 14 ]$$

$${V}_{π} ( S ) = [ {Q}_{π} ( S , a ) ] \qquad [ Equation 15 ]$$

The Q-value function Q(S,a) evaluates the value of taking action a in the current state s. The state-value function V(s) can estimate the effectiveness of the actions available in a given state s.

For a policy π, when action a is taken in state s, the advantage function is expressed as Equation 16.

$${G}_{π} ( S , a ) = {Q}_{π} ( S , a ) - {V}_{π} ( S ) \qquad [ Equation 16 ]$$

The foregoing value functions may be obtained using a dueling neural network, in which two fully connected layers are respectively connected to the outputs for the state value V(S) and the advantage G(S,a).

Accordingly, the Q-value function is computed by combining these two outputs, as expressed by Equation 17.

$$Q ( S , a ) = V ( S ) + G ( S , a ) \qquad [ Equation 17 ]$$

Equation 17 can be transformed into Equation 18, and the optimal action is denoted by a*=argmax Q (S,a)=argmax

$$Q ( S , a ) = V ( S ) + ( G ( S , a ) - {max}_{a} G ( S , a ) ) \qquad [ Equation 18 ]$$

Accordingly, Q(S,a*)=V(S), by replacing the max operator with an averaging operator, it may be rewritten as Equation 19.

$$Q ( S , a ) = V ( S ) + ( G ( S , a ) = \frac{1}{\prod } {\sum }_{a} G ( S , a ) ) \qquad [ Equation 19 ]$$

The architecture of the deep dueling approach according to an embodiment is illustrated in FIG. 6.

The UAV applies the traffic-demand density matrix observed in the small-cell environment to a sparse convolution filter (i.e., a sparse convolutional neural network) to extract a feature vector, which is then used as the current state S(t)

Based on the current state S(t), an epsilon-greedy policy may be used to select a near-optimal action a (t). Consequently, the reward U (t) corresponding to the selected action and the next state S(t+1) are obtained, and the tuple <S(t),a(t),U(t),S(t+1)> may be stored in a replay buffer memory.

To learn a near-optimal slot-configuration policy, tuples are randomly sampled from the replay buffer and used to train the deep reinforcement learning model. The model is trained via gradient descent to minimize the Bellman residual estimation error of the Q-value function, and the corresponding loss function is given by Equation 20.

$$ℒ ( θ ) = [ {( y ( t ) - 𝒬 ( S ( t ) , a ( t ) ; θ ) )}^{2} ] \qquad [ Equation 20 ]$$

Here, Ψ denotes the batch size, and

$$y ( t ) = U ( t ) + γ Q ( S ( t + 1 ) , a ( t ) ; θ ) .$$

Hereinafter, system performance of the dynamic TDD control method for the UAV-assisted 6G small-cell network is evaluated in terms of average per-UE throughput. In the following, an exhaustive search(ES)-based optimal control scheme, a greedy scheme, a random scheme, and a centralized dynamic TDD control scheme are benchmarked. The network environment parameters are summarized in FIG. 7, and the testbed is configured as a heterogeneous network composed of a single-tier macro cell and outdoor small cells.

FIG. 8 presents the convergence behavior of the proposed dynamic TDD control method for the UAV-assisted 6G small-cell network. It plots throughput over time for learning rates of 1e-2, 1e-3, and 1e-4, indicating that the algorithm converges after approximately 300 iterations, with 1e-3 achieving the highest performance.

FIG. 9 is a diagram comparing the cumulative distribution function (CDF) of throughput between the proposed dynamic TDD control method for a UAV-assisted 6G small-cell network and conventional techniques.

It can be seen that the proposed dynamic TDD control method for a UAV-assisted 6G small-cell network achieves significantly higher performance than the random and greedy schemes, and approaches the performance of the optimal control.

FIG. 10 compares the proposed dynamic TDD control method for a UAV-assisted 6G small-cell network with conventional (benchmark) techniques as a function of the number of user equipment (UEs), showing that performance decreases as the number of UEs increases.

Similarly, the proposed dynamic time-division duplexing (D-TDD) control method for a UAV-assisted 6G small-cell network achieves significantly higher performance than conventional techniques and approaches the performance of the optimal control.

FIG. 11 compares, as a function of the number of small-cell base stations (BSs), the proposed dynamic time-division duplexing (D-TDD) control method for a UAV-assisted 6G small-cell network with conventional techniques, showing that performance improves as the number of BSs increases. It can also be seen that the proposed method achieves significantly higher performance than the conventional techniques and approaches the performance of the optimal control.

Compared with conventional deep reinforcement learning methods (DQN, DDQN, and DDPG), FIGS. 10 and 11 demonstrate the superiority of the dynamic time-division duplexing (D-TDD) control method for a UAV-assisted 6G small-cell network according to an embodiment, specifically exhibiting an average throughput improvement exceeding 6%.

FIG. 12 is a diagram comparing the uplink and downlink throughputs of macro-cell users and small-cell users between conventional techniques and an embodiment of the UAV-assisted 6G small-cell D-TDD control method.

In FIG. 12, (a) illustrates the uplink and downlink throughputs of macro-cell users, and in FIG. 12, (b) illustrates the uplink and downlink throughputs of small-cell users.

In the downlink, the proposed UAV-assisted 6G small-cell D-TDD control method outperforms the centralized control scheme and approaches the optimal control. In the uplink, all three schemes exhibit nearly identical performance. In addition, the throughput of small-cell users is higher than that of macro-cell users.

As described above, the dynamic time-division duplexing (D-TDD) control method for a UAV-assisted 6G small-cell network, according to an embodiment, has been demonstrated to be superior in terms of average per-UE throughput and, due to its low complexity and near-optimal performance, can be efficiently applied to 6G small-cell network environments.

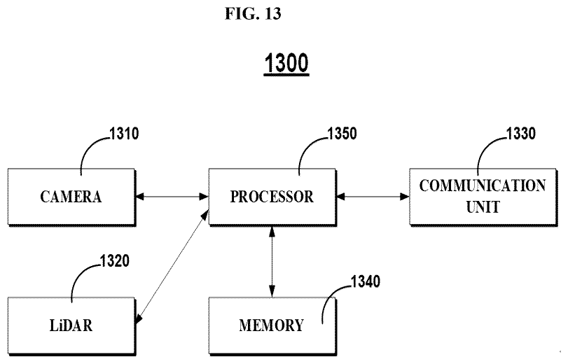

FIG. 13 is a block diagram schematically illustrating an internal configuration of an unmanned aerial vehicle (UAV) according to an embodiment of the present disclosure.

Referring to FIG. 13, the unmanned aerial vehicle 1300 according to an embodiment of the present disclosure includes a camera 1310, a LiDAR 1320, a communication unit 1330, a memory 1340, and a processor 1350.

The camera 1310 and the LiDAR 1320 are configured to acquire location information of base stations and user equipment within the 6G small-cell network coverage.

The communication unit 1330 is configured to transmit and receive data with other devices (e.g., base stations and user equipment) via a communication network.

The memory 1340 stores instructions for performing the dynamic time-division duplexing (D-TDD) control method for a UAV-assisted 6G small-cell network according to an embodiment.

The processor 1350 is configured to control internal components of the UAV (e.g., the camera 1310, the LiDAR 1320, the communication unit 1330, and the memory 1340.

Additionally, the processor 1350 may execute the instructions stored in the memory 1340. When executed by the processor 1350, the instructions cause the UAV to perform a series of operations including: collecting geographic information and channel states for base stations and user equipment within the network coverage and converting the same into a traffic demand density matrix; applying the traffic demand density matrix to a sparse convolutional neural network model to extract a feature vector; defining the extracted feature vector as a current state and inputting the current state into a reinforcement learning model; determining, via the reinforcement learning model and based on the current state, an action for reconfiguring a slot configuration of a base station; and, in response to the determined action, reconfiguring the slot configuration of the base station and computing a state transition and a reward value. These operations are identical to those described above with reference to FIG. 3, and thus a repeated description is omitted.

The device and method according to the embodiments of the present disclosure may be implemented in a program that can be executed by various computers and may be recorded on computer-readable media. The computer-readable media may include program commands, data files, and data structures individually or in combinations thereof. The program commands that are recorded on a computer-readable media may be those specifically designed and configured for the present disclosure or may be those known to those engaged in the computer software field and thus available. The computer-readable recording media include magnetic media such as hard disks, floppy disks, and magnetic media such as a magnetic tape, optical media such as CD-ROMs and DVDs, magneto-optical media such as floptical disks, and hardware devices specifically configured to store and execute program commands, such as ROM, RAM, and flash memory. The program commands include not only machine language codes compiled by a compiler, but also high-level language code that can be executed by a computer using an interpreter, etc.

The hardware device may be configured to operate as one or more software modules to perform the operation of the present disclosure, and vice versa.

The present disclosure was described above focusing on the embodiments thereof. It would be understood by those skilled in the art that the present disclosure may be implemented in a modified form without departing from the scope of the present disclosure. Therefore, the disclosed embodiments should be considered in terms of explaining, not limiting. The scope of the present disclosure is shown in the claims, not in the above description, and all differences within an equivalent range should be construed as being included in the present disclosure.

What is claimed is:

1. A method for dynamic time-division duplexing (D-TDD) control in a UAV-assisted 6G small-cell network, comprising:
collecting geographic location information and channel conditions for base stations (BSs) and user equipment (UEs) within a network coverage area, and converting the collected information into a traffic demand density matrix;
applying the traffic demand density matrix to a sparse convolutional neural network model to extract a feature vector;
defining the extracted feature vector as a current state, inputting the current state into a reinforcement learning (RL) model, and determining, by the RL model based on the current state, an action for reconfiguring a slot configuration of a BS; and,
in response to the determined action, reconfiguring the slot configuration of the BS and computing a state transition and a reward value.

2. The method of claim 1,
wherein the slot configuration comprises an uplink (UL) state, a downlink (DL) state, and a flexible (F) state,
wherein the flexible state does not assign a specific transmission direction and is a state in which neither throughput nor interference occurs.

3. The method of claim 1,
wherein converting into the traffic demand density matrix comprises:
partitioning the network coverage into grids or cells of a predetermined size;
for each grid or cell, calculating a traffic density value by summing a number of user equipment (UEs) within the grid or cell and an amount of traffic demanded by the UEs within the grid or cell; and
generating, based on the respective traffic density values, the traffic demand density matrix for the entire network coverage.

4. The method of claim 1,
wherein, to construct the traffic demand density matrix, each base station is positioned at an origin of a local coordinate system, and location information of user equipment (UEs) connected to the base station and UEs not connected to the base station is stored in tuple form.

5. The method of claim 1,
wherein the traffic demand density matrix comprises a first density matrix for downlink traffic density of served or connected user equipment (UEs), a second density matrix for uplink traffic density of served or connected UEs, a third density matrix for downlink traffic density of unconnected UEs, and a fourth density matrix for uplink traffic density of unconnected UEs.

6. The method of claim 1,
wherein the reward value is an aggregate throughput of the user equipment (UEs).

7. The method of claim 6,
wherein the reward value is calculated using the following mathematical expression.
$$U ( t ) = {\sum }_{u = 1}^{U} {\sum }_{k = 0}^{K} {( {R}_{u , k , n}^{UL} ( t ) + {R}_{u , k , n}^{DL} ( t ) )}_{n = t \% N}$$
wherein, u denotes an index of a user equipment (UE), k denotes an index of a base station (BS), n denotes a time index,
$${R}_{u , k , n}^{UL} ( t )$$
denotes the uplink transmission rate between UE u and BS k at time n, and
$${R}_{u , k , n}^{DL} ( t )$$
denotes the downlink transmission rate between UE u and BS k at time n.

8. The method of claim 1, further comprising storing, in a replay buffer, a tuple comprising the current state, the selected action, the reward value, and a next state; and randomly sampling tuples from the replay buffer to train the reinforcement learning (RL) model.

9. A non-transitory computer-readable medium storing program code which, when executed by one or more processors, causes a computer to perform the method of claim 1.

10. An unmanned aerial vehicle (UAV) having a camera and a LiDAR and configured to perform a dynamic time-division duplexing (D-TDD) control method for a 6G small-cell network, the UAV comprising:
a communication unit;
a memory storing one or more instructions; and
a processor configured to execute the instructions to:
collect geographic location information and channel conditions for base stations and user equipment within a network coverage area and convert the collected information into a traffic demand density matrix;
apply the traffic demand density matrix to a sparse convolutional neural network (CNN) model to extract a feature vector;
define the extracted feature vector as a current state, input the current state into a reinforcement learning (RL) model, and, based on the current state, determine an action for reconfiguring a slot configuration of a base station; and,
in response to the determined action, reconfigure the slot configuration of the base station and compute a state transition and a reward value.

11. The UAV of claim 10,
wherein the slot configuration comprises an uplink (UL) state, a downlink (DL) state, and a flexible (F) state,
wherein the flexible state does not assign a specific transmission direction and is a state in which neither throughput nor interference occurs.

12. The UAV of claim 10,
wherein converting into the traffic demand density matrix comprises:
partitioning the network coverage into grids or cells of a predetermined size;
for each grid or cell, calculating a traffic density value by summing a number of user equipment (UEs) within the grid or cell and an amount of traffic demanded by the UEs within the grid or cell; and
generating, based on the respective traffic density values, a traffic demand density matrix for the entire network coverage.

13. The UAV of claim 10,
wherein the traffic demand density matrix comprises a first density matrix for downlink traffic density of served or connected user equipment (UEs), a second density matrix for uplink traffic density of served or connected UEs, a third density matrix for downlink traffic density of unconnected UEs, and a fourth density matrix for uplink traffic density of unconnected UEs.

14. The UAV of claim 10,
wherein the reward value is an aggregate throughput of the user equipment (UEs) and is calculated using the following mathematical expression.
$$U ( t ) = {\sum }_{u = 1}^{U} {\sum }_{k = 0}^{K} {( {R}_{u , k , n}^{UL} ( t ) + {R}_{u , k , n}^{DL} ( t ) )}_{n = t \% N}$$
wherein, u denotes an index of a user equipment (UE), k denotes an index of a base station (BS), n denotes a time index,
$${R}_{u , k , n}^{UL} ( t )$$
denotes the uplink transmission rate between UE u and BS k at time n, and
$${R}_{u , k , n}^{DL} ( t )$$
denotes the downlink transmission rate between UE u and BS k at time n.

15. The UAV of claim 10,
wherein the instructions further cause the processor to: store, in a replay buffer, a tuple comprising the current state, the selected action, the reward value, and a next state; and train the reinforcement learning (RL) model by randomly sampling tuples from the replay buffer.
